(19) United States
(12) Patent Application Publication
(10) Pub. No.: US 2007/0061386 A1
(43) Pub. Date: Mar. 15, 2007

(54) Method, system and program product for performing an integrated information technology (IT) migration and inventory information collection

(75) Inventors: Tamera Hancock, San Jose, CA (US); Scott D. Hicks, Underhill Center, VT (US); James A. Martin JR., Endicott, NY (US); William D. Montgomery, Moreland, GA (US); Douglas G. Murray, Johnson City, NY (US); Shawn S. Oshiro, Gilroy, CA (US); Nan Pay, San Jose, CA (US); Jeffrey E. Prince, Bloomfield Hills, MI (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/215,755

(22) Filed: Aug. 30, 2005

(51) Int. Cl. G06F 17/30

(52) U.S. Cl. 707/204

(57) ABSTRACT

Under the present invention, an IT migration and corresponding information collection are conducted in a single visit. A directory such as an electronic mail directory of an organization (i.e., for which the IT migration is being performed) is first analyzed to identify contacts (e.g., employees) for the IT migration. Then, a message is sent to each of the contacts containing instructions for the IT migration. The instructions will typically include, among other things, a schedule for performing the IT migration. Thereafter, each of the contacts is visited according to the schedule(s) with all components needed to perform the IT migration. At the single visit, the IT migration will be performed and inventory information collected for each of the contacts that are present when visited. Finally, transaction details corresponding to the IT migration and the inventory information are recorded.

### Cross-Reference to Related Applications

The present invention is related in some aspect to the commonly owned co-pending patent application identified by Attorney Docket No. END920040197US 1 entitled “System, Method and Program Product for Managing Communications Pursuant to an Information Technology (IT) Migration,” herein incorporated by reference. The present invention is also related in some aspect to the commonly owned co-pending patent application identified by application serial number 10,728,520, filed Dec. 4, 2003 and entitled “Method and System for Enterprise-Wide Migration,” herein incorporated by reference.

### BACKGROUND OF THE INVENTION

1. Field of Invention

The present invention generally relates to IT migration. Specifically, the present invention provides an on-demand method, system and program product for performing an integrated IT migration and inventory information collection.

2. Related Art

As Information Technology (IT) continues to advance, many organizations are faced with the task of migrating their existing computer infrastructures, telephone systems and the like to newer technology. For example, an organization might wish to migrate its networking functions from token ring to Ethernet. Similarly, an organization might wish to migrate its telephone service from landline-based service to voice-over-IP service.

To accomplish the desired migration, an organization might often hire an outside service-provider that will gather needed information and perform the actual migration. Unfortunately, performing IT migrations such as these have historically been extremely expensive and labor-intensive processes. Specifically, IT migrations prior to the present invention necessitated numerous physical visits, telephone calls, and individual electronic mail messages for announcements, gathering of information and scheduling the actual migration. For example, a first visit with an employee/contact is conducted to gather the necessary information. Then, after a period of planning and equipment procurement and preparation, a second visit with the employee is made to perform the actual migration. This multi-step process requires, among other things, labor to schedule and perform the two visits; communications preceding each visit; individually scheduling the migration visit with each employee; calculation of the required quantities of various components needed for the migration; and enough elapsed time between visits to allow for ordering components, etc. As can be seen, such a process is both time consuming and expensive.

In view of the foregoing, there exists a need for an on-demand method, system and program product for performing an integrated IT migration and inventory information collection. Specifically, a need exists for a way to consolidate an IT migration as well as the collection of any associated information (e.g., inventory information) into a single visit.

### SUMMARY OF THE INVENTION

In general, the present invention provides an on-demand method, system and program product for performing an integrated IT migration and inventory information collection. Specifically, under the present invention, the IT migration and corresponding information collection are conducted in a single visit. A directory such as an electronic mail directory of an organization (i.e., for which the IT migration is being performed) is first analyzed to identify contacts (e.g., employees) for the IT migration. Then, a message is sent to each of the contacts containing instructions for the IT migration. The instructions will typically include, among other things, a schedule for performing the IT migration. Thereafter, each of the contacts is visited according to the schedule(s) with all components needed to perform the IT migration. At the single visit, the IT migration will be performed and inventory information collected for each of the contacts that are present. Finally, transaction details corresponding to the IT migration and the inventory information are recorded. The transaction details can specify, among other things, whether the IT migration was performed (e.g. whether the contacts were present), the components (e.g., hardware and software) that were installed pursuant to the IT migration, and the labor that was required to perform the migration. In addition, the present invention will make a record of any systems that could not be migrated so that a follow-up visit can be scheduled.

A first aspect of the present invention provides a method for performing an integrated Information Technology (IT) migration and inventory information collection, comprising: analyzing a directory of an organization to identify contacts for an IT migration; sending a message to each of the contacts containing instructions for the IT migration; visiting each of the contacts according to a schedule set forth in the instructions with all components needed to perform the IT migration; performing the IT migration and collecting inventory information in a single visit for each of the contacts that are present when visited; and recording transaction details corresponding to the IT migration and the inventory information.

A second aspect of the present invention provides a system for performing an integrated inventory information collection and Information Technology (IT) migration, comprising: a system for analyzing a directory of an organization to identify contacts for the IT migration; a system for creating instructions for the IT migration, wherein the instructions include a schedule for performing the IT migration; a system for sending a message containing the instructions to each of the contacts, wherein each of the contacts are visited according to the schedule with all components needed to perform the IT migration, and wherein the IT migration is performed and inventory information is collected in a single visit for each of the contacts that is present when visited; and a system for recording transaction details corresponding to the IT migration and the inventory information.

A third aspect of the present invention provides a program product stored on a computer readable medium for performing an integrated inventory information collection and Information Technology (IT) migration, the computer readable medium comprising program code for performing the following steps: analyzing a directory of an organization to identify contacts for the IT migration; creating instructions for the IT migration, wherein the instructions include a schedule for performing the IT migration; sending a message containing the instructions to each of the contacts, wherein each of the contacts are visited according to the schedule with all components needed to perform the IT migration, and wherein the IT migration is performed and inventory information is collected in a single visit for each of the contacts that is present when visited; and recording transaction details corresponding to the IT migration and the inventory information.

A fourth aspect of the present invention provides a method for deploying an application for performing an integrated inventory information collection and Information Technology (IT) migration, comprising providing a computer infrastructure being operable to: analyze a directory of an organization to identify contacts for the IT migration; create instructions for the IT migration, wherein the instructions include a schedule for performing the IT migration; send a message containing the instructions to each of the contacts, wherein each of the contacts are visited according to the schedule with all components needed to perform the IT migration, and wherein the IT migration is performed and inventory information is collected in a single visit for each of the contacts that is present when visited; and record transaction details corresponding to the IT migration and the inventory information.

A fifth aspect of the present invention provides computer software embodied in a propagated signal for performing an integrated inventory information collection and Information Technology (IT) migration, the computer software comprising instructions for causing a computer system to perform the following functions: analyze a directory of an organization to identify contacts for the IT migration; create instructions for the IT migration, wherein the instructions include a schedule for performing the IT migration; send a message containing the instructions to each of the contacts, wherein each of the contacts are visited according to the schedule with all components needed to perform the IT migration, and wherein the IT migration is performed and inventory information is collected in a single visit for each of the contacts that is present when visited; and record transaction details corresponding to the IT migration and the inventory information.

A sixth aspect of the invention provides a computer-readable medium that includes computer program code to enable a computer infrastructure to perform an integrated inventory information collection and Information Technology (IT) migration.

A seventh aspect of the invention provides a business method for performing an integrated inventory information collection and Information Technology (IT) migration.

An eighth aspect of the invention provides a method for performing an integrated inventory information collection and Information Technology (IT) migration.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for performing an integrated inventory information collection and Information Technology (IT) migration according to the present invention.

FIG. 2 shows an illustrative screen shot for creating instructions according to the present invention.

FIG. 3 shows an illustrative screen shot depicting transaction details as recorded according to the present invention.

FIG. 4 shows an illustrative method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the present invention provides an on-demand method, system and program product for performing an integrated IT migration and inventory information collection. Specifically, under the present invention, the IT migration and corresponding information collection are conducted in a single visit. A directory such as an electronic mail directory of an organization (i.e., for which the IT migration is being performed) is first analyzed to identify contacts (e.g., employees) for the IT migration, grouping them in a logical fashion, such as by building and floor, or by network closet that provides network connectivity. Then, a message is sent to each of the contacts containing instructions for the IT migration. The instructions will typically include, among other things, a schedule for performing the IT migration. Thereafter, each of the contacts is visited according to the schedule(s) with all components needed to perform the IT migration. At the single visit, the IT migration will be performed and inventory information collected for each of the contacts that are present. Finally, transaction details corresponding to the IT migration and the inventory information are recorded. The transaction details can specify, among other things, whether the IT migration was performed (e.g. whether the contacts were present), as well as the components (e.g., hardware and software) that were installed pursuant to the IT migration, and the labor that was needed to perform the migration. In addition, the present invention will make a record of the systems/elements that could not be migrated so that a follow-up visit can be scheduled.

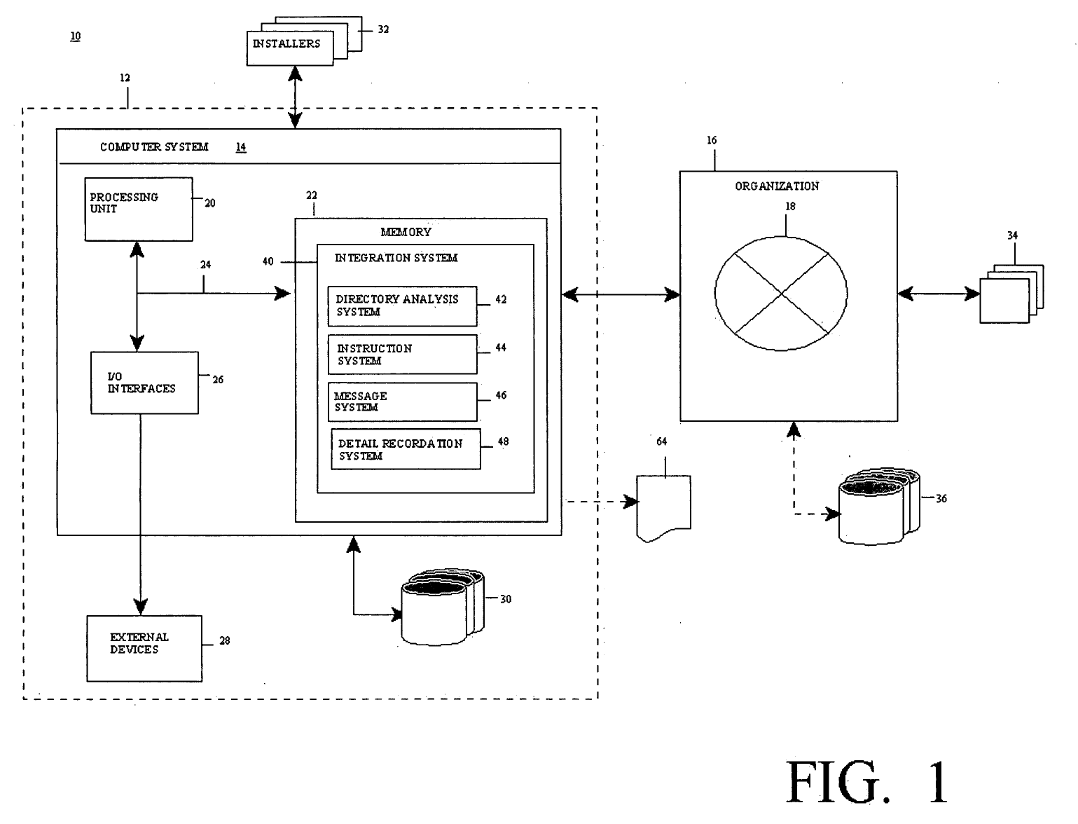

Referring now to FIG. 1, a system 10 for providing an on-demand method, system and program product for performing an integrated IT migration and inventory information collection according to the present invention is shown. As depicted, system 10 includes a computer infrastructure 12, which comprises a computing system 14 that can perform the various process steps described herein. Computer system 14 is intended to represent any type of computer system capable of carrying out the teachings of the present invention. For example, computer system 14 could be a laptop computer, a desktop computer, a workstation, a handheld device, etc. In addition, as will be further described below, computer system 14 can be deployed and/or operated by a service provider that is performing the IT migration for organization 16 (with which computer system 14 is in communication). Organization 16 is intended to represent any type of individual, group of individuals, company, etc. that is experiencing an IT migration. Examples of IT migrations include, among others, migration of networking functions from token ring to Ethernet, migration of telephone service from landline-based service to voice-over-IP service, migration from one desktop operating system to another, installation of security devices or software, technology needed for movement to a new building, etc.

As further depicted, organization 16 includes its own infrastructure 18, that is intended to represent any type of IT or computerized infrastructure/environment that may be implemented by organization 16. For example, infrastructure 18 can contain hardware (e.g., computer systems, networking components, telephone components, etc.), software (e.g., applications, server software, client software, etc.), or any combination thereof. In addition, infrastructure 18 can contain or communicate with directories 36 for organization 16 such as an electronic mail directory, a telephone switch/directory, an electronic company/organization directory, etc.

In any event, under the present invention, an IT migration will be performed and inventory information collected in a single visit to organization 16 (i.e., in an integrated fashion). To provide this functionality, integration system 40 is shown implemented on computer system 14 as computer program code. To this extent, computer system 14 is shown including a processing unit 20, a memory 22, a bus 24, and an input/output (I/O) interface 26. Further, computer 14 is shown in communication with external I/O devices/resources 28 and one or more storage systems 30. In general, processing unit 20 executes computer program code, such as integration system 40, that is stored in memory 22 and/or storage system(s) 30. While executing computer program code, processing unit 20 can read and/or write data, to/from memory 22, storage system(s) 30, and/or I/O interface 26. Bus 24 provides a communication link between each of the components in computer system 14. I/O devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices, such as those in organization 16.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. In this case, the network can comprise one or more types of networks (e.g., the Internet, a wide area network (WAN), a local area network (LAN), a virtual private network (VPN), etc.), and communications between the computing devices may utilize various types of communications links and/or transmission techniques (e.g., wired, wireless, etc.).

Still yet, communications between computer system 12 and organization 16 can occur over one or more networks. Such a network can comprise any combination of various types of communications links. For example, the network can comprise addressable connections that may utilize any combination of wired and/or wireless transmission methods. Further, the network can comprise one or more of any type of network, including the Internet, a WAN, a LAN, a VPN, etc. Where communications occur via the Internet, connectivity could be provided by conventional TCP/IP sockets-based protocol, and a computing device could utilize an Internet service provider to establish connectivity to the Internet.

Computer system 14 is only representative of various possible computer infrastructures that can include numerous combinations of hardware. For example, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more I/O devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more I/O devices 28 (e.g., a display) and/or storage system(s) 30 could be contained within computer system 14, not externally as shown.

Storage system 30 and directories 36 can be any type of systems (e.g., databases) capable of providing storage for information under the present invention. To this extent, storage system 30 and directories 36 could each include one or more storage devices, such as a magnetic disk drive or an optical disk drive. In another embodiment, storage system 30 and directories 36 include data distributed across, for example, a local area network (LAN), wide area network (WAN) or a storage area network (SAN) (not shown). Although not shown, additional components, such as cache memory, communication systems, system software, etc., may be incorporated into computer system 14. Moreover, although not shown for brevity purposes, computer systems existing within infrastructure 18 of organization 16 will likely contain computerized components similar to computer system 14.

Shown in memory 22 of computer system 14 is integration system 40, which includes directory analysis system 42, instruction system 44, message system 46, and detail recordation system 48. Operation of each of these systems is discussed further below. However, it is understood that some of the various systems shown in FIG. 1 can be implemented independently, combined, and/or stored in memory for one or more separate computers systems 14 that communicate over a network. Further, it is understood that some of the systems/functionality may not be implemented and/or additional systems/functionality may be included as part of the present invention. Still yet, it is understood that the depiction of these systems shown in FIG. 1 is illustrative only and that the same functionality could be achieved with a different configuration. That is, the functionality of these systems could be combined into fewer systems, or broken down into additional systems.

Illustrative Example

In an illustrative example, assume that organization 16 desires to migrate its networking functions from token ring to Ethernet on an enterprise-wide level. As discussed above, such a migration under previous systems involved multiple physical visits to organization 16 as well as multiple rounds of communications with the individuals thereof. The present invention provides a way to perform such a migration and collect information in a single visit.

Under the present invention, directory analysis system 42 will first analyze infrastructure 18 of organization 16 to identify the pertinent contacts 34 for the migration. In one embodiment, directory analysis system 42 will generate a distribution list 64 of contacts 34 by analyzing one or more directories 36 of organization 16 such as an electronic mail directory, a telephone switch, an electronic company directory, etc. Specifically, directory analysis system 42 is programmed to parse a designated directory and extract contact information therefrom. It should be understood, however, that any part of infrastructure 16 that could yield a distribution list 64 of contacts 34 could be analyzed.

Once contacts 34 have been identified, instruction system 44 will be used (e.g., by installers/workers 32) to create/generate instructions for contacts 34. The instructions typically indicate a proposed schedule(s) for performing the IT migration. The instructions can also include additional information such as actions that contacts must take to prepare for the IT migration and/or instructions for operating after the IT migration has been performed. In a typical embodiment instruction system will provide one or more interface pages at which schedules can be designated and information provided.

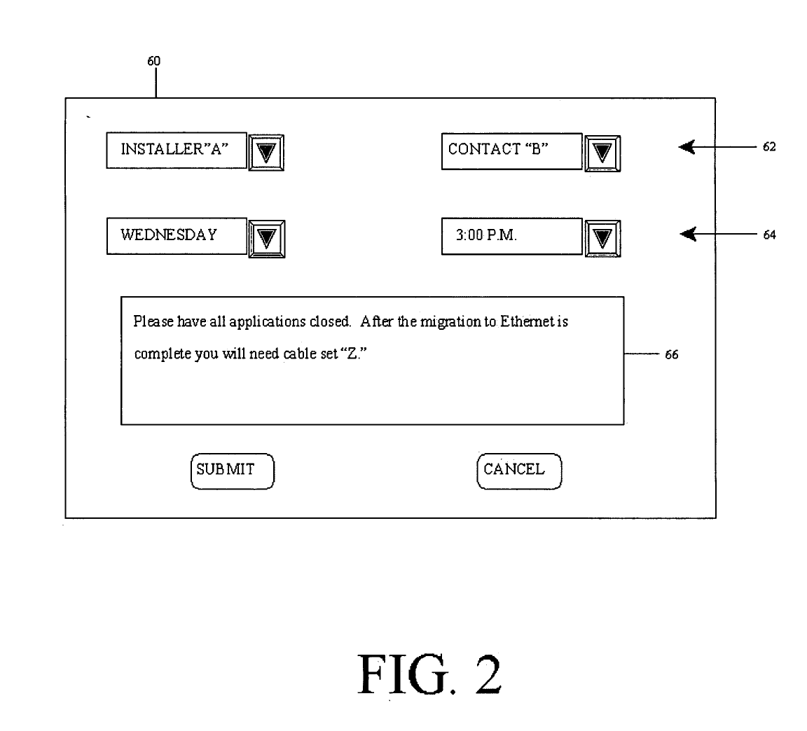

Referring now to FIG. 2, an illustrative screen shot 60 depicting such an interface page is shown. As depicted, interface page 60 includes a set of mechanisms 62 (e.g., drop-down menus) for designating/selecting a particular installer and contact, a set of mechanisms 64 for designating/selecting a schedule for performing the integrated inventory information collection and IT migration, as well as a mechanism 66 (e.g. a text box) for inputting additional instructions. It should be understood that screen shot 60 is intended to be illustrative only and that other variations could be implemented. For example, a group of contacts could be selected via mechanism 62 (instead of a single contact). Moreover, the use of the drop-down menus and the text box could be substituted with any equivalent now known or later developed.

In any event, once the instructions have been created, message system 46 will generate and send a message to each of the contacts 34. The contacts may be categorized into logical groups, such as people who reside on a particular floor in a building, or people whose network connectivity is provided by the devices in a single network closet that is being migrated. The invention provides the means of sending communications to one or more of these logical groups according to the scheduled migration date(s).

In typical embodiment, the messages are electronic (e.g., email message, text message, short message, etc.) and include the instructions with the schedule(s) for performing the IT migration. Message system 46 is also capable of handling any responses (e.g., request for different dates/times, etc.) such as described in the above-incorporated patent application. Out of the office replies and the like that are automatically sent from an absent contact 34 will be handled as a response. On such occasions, message system 46 could be programmed to automatically send a message to the relevant installer 32 informing them of the out of the office reply. In another embodiment, message system 46 could be capable of interpreting out of the office replies so that if a return date/time is specified therein, a revised schedule that meets with such a date/time can be automatically proposed.

To perform the IT migration one or more installers 32 will visit each of the contacts 34 with all components (e.g., hardware, software, etc.) needed to perform the IT migration. In previous systems, the installers would first communicate with or visit contacts 34 to gather information needed to plan the migration, such as:
to determine what components are needed for the migration,
what skills will be needed to migrate particular devices,
whether movers are needed to gain access to facilities such as network or telephone ports that are behind heavy furniture
   then technicians with the necessary skills re-visit the contacts 34 with just those components. Conversely, installers 32 under the present invention will make a single visit at the schedule date/time and carry with him/her all components that might be needed. If different skills are needed or if movers are required, there can be other technicians available to handle that migration that day, or the migration can be rescheduled.

For all contacts 34 that are present when visited, the IT migration will be performed and inventory information will be collected (i.e., thus, the IT migration and inventorying of the corresponding systems are “integrated,” or performed in a common visit). Performing the IT migration typically involves the installation and/or removal of components onto computer systems (or the like) of contacts 34. Inventory information generally identifies the components that were installed and/or removed pursuant to the IT migration. It could also include other information such as certain configuration settings of the contacts' 34 computer systems, network port ID numbers, machine manufacturer, model types and numbers, serial numbers, network addresses, operating systems, etc. In any event, any contacts 34 that are absent when visited, or systems/elements could not be migrated for any reason, will be rescheduled. A record is made in storage system 30 (e.g., by detail recordation system 48) of the systems/elements that could not be migrated (e.g., were not migrated or were unsuccessfully migrated), along with identifying information such as the type of system, model type and number, serial number, location, and information on the contact person. The invention provides the capability to facilitate the rescheduling of these migrations by displaying them together in customized views in the database, automating the assignment of new dates, and automating the sending of e-mails or other communications to the owners of the systems to notify them of the new dates.

Pursuant to the IT migration and the collection of inventory information, detail recordation system 48 can then be used by the installers 32 to record transaction details. Such details typically include whether the IT migration was performed successfully for each contact 34 (e.g., what contacts 34 were present, what contacts 34 were absent, etc.). Transaction details can also include the inventory information collected for each contacts 34 for who the migration was performed, as well other information such as the identity of contacts 34, their corresponding hardware identifications, etc. To this extent, detail recordation system 48 could generate and display an interface page into which the transaction details are entered. Thus, in one embodiment, computer system 14 on which integration system 40 is loaded could be a portable computer system that installers 32 carry with them when performing the IT migration. Although, this need not be the case

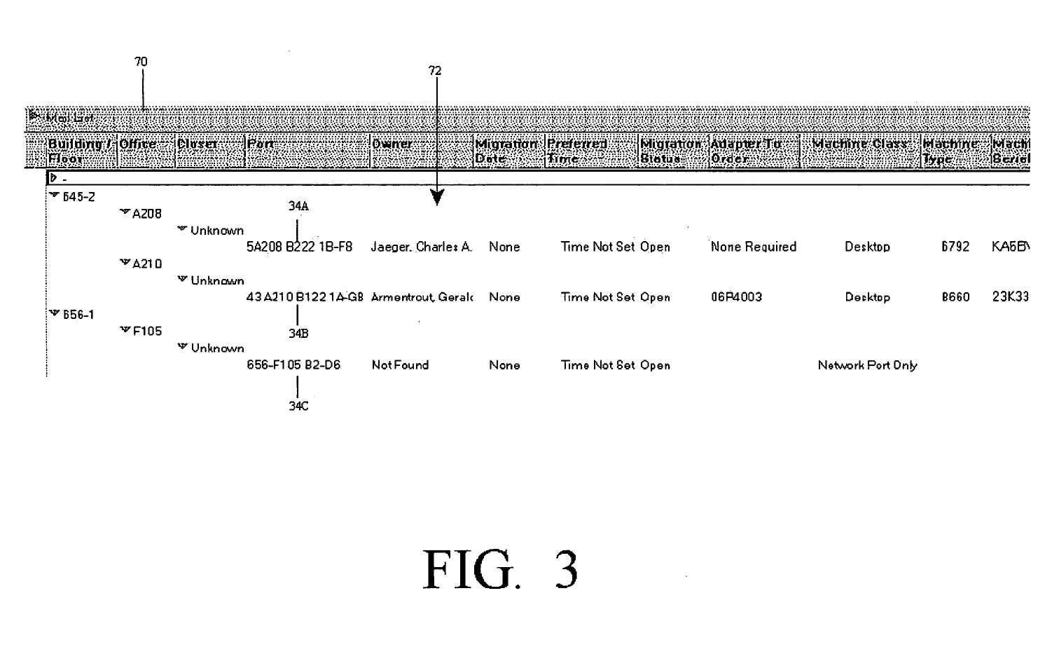

Referring to FIG. 3, an illustrative screen shot 70 containing transaction details 72 is depicted. Specifically, screen shot 70 depicts transaction details for three contacts 34A-C that are identified by ports and/or human owners. Each of these contacts 34A-C was absent when visited and thus, the IT migration was not performed for them (as indicated by the term “None” as appearing in the Migration Date column). As can be seen, the transaction details for contacts 34A-C identify their respective Buildings/Floors and Offices, and indicate the Migration Date, Preferred Time and Status. Further the transaction details can include the inventory information such as the components that would have been installed (e.g., Adapter to Order) and/or removed pursuant to the IT migration as well as information corresponding to the machines on which the IT migration is being performed (e.g., Machine Class, Machine Type, Machine Serial Number, etc.)

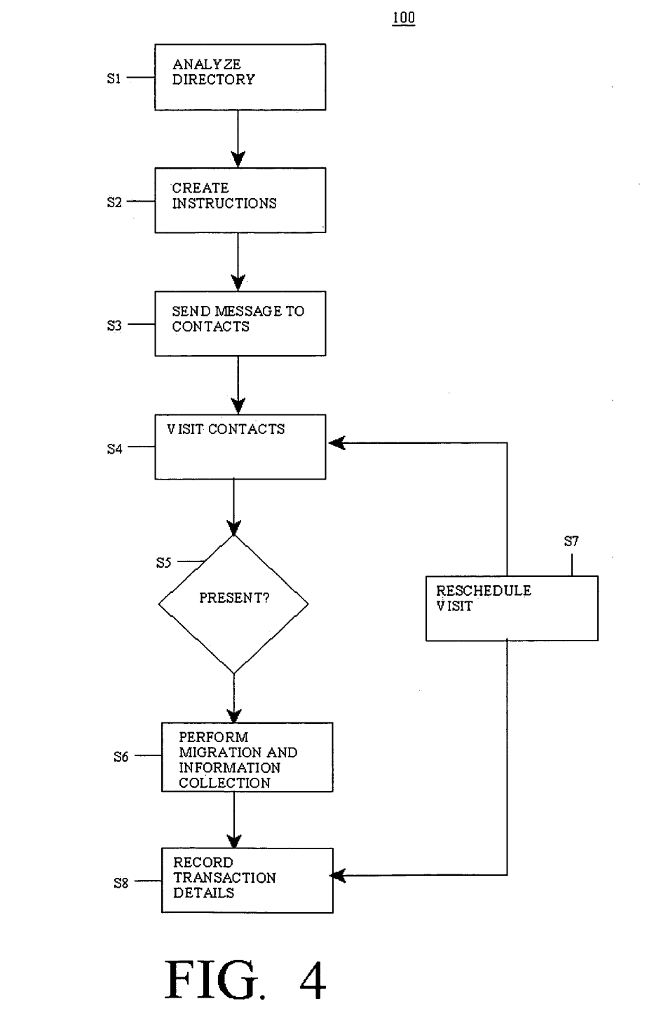

Referring now to FIG. 4, a method flow diagram 100 according to the present invention is shown. As depicted, first step S1 is to analyze a directory of the organization to identify contacts for an IT migration. Typically, the directory analyzed is an electronic directory that can be automatically parsed by directory analysis system 42. Second step S2 is to create instructions for IT migration. Among other things, the instructions set forth a schedule(s) for performing the IT migration. Third step S3 is to send a message to each of the contacts containing the instructions. Any replies that are received from the contacts can be handled as discussed above. Fourth step S4 is to visit each of the contacts according to the schedule set forth in the instructions with all components needed to perform the IT migration. Then, in sixth step S6, the IT migration will be performed and inventory information will be collected in a single visit for each of the contacts that are determined to be present in fifth step S5 present when visited. Any contacts that are not present in step S5, will have their IT migrations reschedule in step S7. In step S8, transaction details corresponding to the IT migration and the inventory information are recorded. In addition to indicating whether the IT migration was successfully completed, the transaction details can include the inventory information about the components that were installed and or removed pursuant to the IT migration, along with the labor needed to perform the migration.

While shown and described herein as a method and system for performing an integrated IT migration and inventory information collection, it is understood that the invention further provides various alternative embodiments. For example, in one embodiment, the invention provides a computer-readable medium that includes computer program code to enable a computer infrastructure to performing an integrated IT migration and inventory information collection. To this extent, the computer-readable medium includes program code that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider, such as an Internet Service Provider, could offer to perform an integrated IT migration and inventory information collection as described above. In this case, the service provider can create, maintain, support, etc., a computer infrastructure, such as computer infrastructure 12 (FIG. 1), that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a method of generating a system for performing an integrated IT migration and inventory information collection. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computing device 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for performing an integrated Information Technology (IT) migration and inventory information collection, comprising:
analyzing a directory of an organization to identify contacts for an IT migration;
sending a message to each of the contacts containing instructions for the IT migration;
visiting each of the contacts according to a schedule set forth in the instructions with all components needed to perform the IT migration;
performing the IT migration and collecting inventory information in a single visit for each of the contacts that are present when visited; and
recording transaction details corresponding to the IT migration and the inventory information.

2. The method of claim 1, wherein the directory is an electronic directory selected from the group consisting of an electronic mail directory, a telephone directory and an organization directory.

3. The method of claim 1, wherein the message is an electronic message.

4. The method of claim 1, wherein the instructions further contain actions for the contacts to take to prepare for the IT migration.

5. The method of claim 1, wherein the IT migration is rescheduled for each of the contacts that is not present during the visiting step.

6. The method of claim 1, wherein the transaction details indicate an absence of each of the contacts that is not present during the visiting step, and further indicate a success of the IT migration and the inventory information collected for each of the contacts that is present during the visiting step.

7. The method of claim 1, wherein the components include hardware and software components needed to perform the IT migration.

8. The method of claim 1, wherein the inventory information identifies the components that were installed into computer systems for each of the contacts and labor that was needed to perform the IT migration.

9. The method of claim 1, wherein the performing step comprises performing the IT migration on computer systems of each of the contacts that is present during the visiting step using the components.

10. The method of claim 1, further comprising making a record of any components that were unsuccessfully migrated during the IT migration.

11. A system for performing an integrated inventory information collection and Information Technology (IT) migration, comprising:
a system for analyzing a directory of an organization to identify contacts for the IT migration;
a system for creating instructions for the IT migration, wherein the instructions include a schedule for performing the IT migration;
a system for sending a message containing the instructions to each of the contacts, wherein each of the contacts are visited according to the schedule with all components needed to perform the IT migration, and wherein the IT migration is performed and inventory information is collected in a single visit for each of the contacts that is present when visited; and
a system for recording transaction details corresponding to the IT migration and the inventory information.

12. The system of claim 11, wherein the directory is an electronic directory selected from the group consisting of an electronic mail directory, a telephone directory and an organization directory.

13. The system of claim 11, wherein the message is an electronic message.

14. The system of claim 11, wherein the instructions further contain actions for the contacts to take to prepare for the IT migration.

15. The system of claim 11, wherein the IT migration is rescheduled for each of the contacts that is not present when visited.

16. The system of claim 11, wherein the transaction details indicate an absence of each of the contacts that is not present when visited, and further indicate a success of the IT migration and the inventory information collected for each of the contacts that is present when visited.

17. The system of claim 11, wherein the components include all hardware and software components needed to perform the IT migration.

18. The system of claim 11, wherein the inventory information identifies the components that were installed into computer systems for each of the contacts.

19. A program product stored on a computer readable medium for performing an integrated inventory information collection and Information Technology (IT) migration, the computer readable medium comprising program code for performing the following steps:
analyzing a directory of an organization to identify contacts for the IT migration;
creating instructions for the IT migration, wherein the instructions include a schedule for performing the IT migration;
sending a message containing the instructions to each of the contacts, wherein each of the contacts are visited according to the schedule with all components needed to perform the IT migration, and wherein the IT migration is performed and inventory information is collected in a single visit for each of the contacts that is present when visited; and
recording transaction details corresponding to the IT migration and the inventory information.

20. The program product of claim 19, wherein the directory is an electronic directory selected from the group consisting of an electronic mail directory, a telephone directory and an organization directory.

21. The program product of claim 19, wherein the message is an electronic message.

22. The program product of claim 19, wherein the instructions further contain actions for the contacts to take to prepare for the IT migration.

23. The program product of claim 19, wherein the IT migration is rescheduled for each of the contacts that is not present when visited.

24. The program product of claim 19, wherein the transaction details indicate an absence of each of the contacts that is not present when visited, and further indicate a success of the IT migration and the inventory information collected for each of the contacts that is present when visited.

25. The program product of claim 19, wherein the components include all hardware and software components needed to perform the IT migration.

26. The program product of claim 19, wherein the inventory information identifies the components that were installed into computer systems for each of the contacts.
